(19) United States
(12) Patent Application Publication
(10) Pub. No.: US 2014/0041298 A1
(43) Pub. Date: Feb. 13, 2014

(54) MOBILE STOWABLE PLANTER TRAY CARRIAGE

(71) Applicant: David Mack, Greensboro, NC (US)

(72) Inventor: David Mack, Greensboro, NC (US)

(21) Appl. No.: 13/964,066

(22) Filed: Aug. 10, 2013

Related U.S. Application Data
(60) Provisional application No. 61/681,697, filed on Aug. 10, 2012.

(51) Int. Cl. A01G 9/02; B62B 3/10; B62B 1/26

(52) U.S. Cl. CPC A01G 9/02; B62B 1/26; B62B 3/10
USPC 47/66.6

(57) ABSTRACT

A planter tray carriage includes a plurality of planter trays affixed to the carriage. The planter tray carriage can be operable in a plurality of states, wherein the states enable selective upright storage of the carriage or deployment of the carriage and the associated trays. The carriage includes the plurality of planter trays attached to the carriage such that the trays remain upright in each of the plurality of states.

### CROSS REFERENCE TO RELATED APPLICATIONS

This disclosure claims the benefit of U.S. Provisional Application No. 61/681,697 filed on Aug. 10, 2012 which is hereby incorporated by reference.

### TECHNICAL FIELD

This disclosure is related to planter trays used to grow plants, particularly to compact storage of the trays and flexible deployment of the trays when not in storage.

### BACKGROUND

The statements in this section merely provide background information related to the present disclosure. Accordingly, such statements are not intended to constitute an admission of prior art.

Planter trays are used to grow and cultivate plants. Planter trays can be used by individuals, for example, permitting a person to keep a small garden on a patio or deck where ground for a normal garden is not available. Planter trays can also be used by merchants, providing plants for public purchase in a mobile container.

Plants need adequate sunlight. Plants can also have particular needs and can thrive based upon selective placement at different times of day and in different weather conditions. Planters provide mobility for the person tending the plants, in that planters are small enough that they can be easily moved into sunlight or under cover.

Planters can take up a lot of room, for example, making a small patio or deck difficult for a family to use. Moving a number of planters around for the benefit of the plants and then moving the plants around to make the space available for the enjoyment of people can be difficult or time consuming.

A merchant can have a large number of planters in a store. Planters take up space, and a number of aisles of planters can be required to provide an adequate selection of plants for consumers to buy. Plants are delicate, and they also tend to leave a floor with a lot of debris. Dirt from the planters gets on the floor, and leaves and parts of plants can fall on the ground. Consumers can leave litter, but consumers still expect a retail store to be well kept and clean. Rows of planters can require significant labor to clean the floor and adequately water the plants.

Farmers' markets are events wherein local farmers bring produce and goods for consumers to buy. Farmers' markets benefit from providing consumers with the impression that the produce offered is fresh and was not picked from the plant a long time ago.

### SUMMARY

A planter tray carriage includes a plurality of planter trays affixed to the carriage. The planter tray carriage can be operable in a plurality of states, wherein the states enable selective upright storage of the carriage or deployment of the carriage and the associated trays. The carriage includes the plurality of planter trays attached to the carriage such that the trays remain upright in each of the plurality of states.

### BRIEF DESCRIPTION OF THE DRAWINGS

One or more embodiments will now be described, by way of example, with reference to the accompanying drawings, in which:

FIG. 1 illustrates an exemplary planter tray carriage in a horizontal, deployed state, in accordance with the present disclosure;

FIG. 2 illustrates a planter tray from FIG. 1 including pivoting hardware, in accordance with the present disclosure;

FIG. 3A illustrates an exemplary side support of a planter tray carriage including a first exemplary tray holder configuration, in accordance with the present disclosure;

FIG. 3B illustrates an exemplary side support of a planter tray carriage including a second exemplary tray holder configuration, in accordance with the present disclosure;

FIG. 3C illustrates the tray holder configuration of FIG. 3B, in accordance with the present disclosure;

FIG. 4 illustrates the planter tray carriage of FIG. 1 in a vertical, stowed state, in accordance with the present disclosure;

FIG. 5 illustrates an exemplary planter tray carriage with a plurality of mature plants and with two planter trays removed, in accordance with the present disclosure;

FIG. 6 illustrates an exemplary planter tray carriage with a wheeled stand employed, providing a partially stowed state for the carriage, in accordance with the present disclosure;

FIG. 7 illustrates an exemplary planter tray carriage with a first flat end configuration, facilitating a vertical, stowed state, in accordance with the present disclosure;

FIG. 8 illustrates an exemplary planter tray carriage with a second flat end configuration, facilitating a vertical, stowed state, in accordance with the present disclosure;

FIG. 9 illustrates an exemplary planter tray carriage and a powered wall storage unit, in accordance with the present disclosure;

FIG. 10 illustrates a truck with exemplary planter tray carriage fixing hardware, in accordance with the present disclosure;

FIG. 11 illustrates a plurality of planter tray carriages for use in a retail store, including powered wall storage units and an automatic watering fixture, in accordance with the present disclosure;

FIG. 12 illustrates an exemplary planter tray carriage with a wheeled stand employed, the stand including a moving linkage assembly and a position locking device, the linkage assembly illustrated in a stowed position, in accordance with the present disclosure; and

FIG. 13 illustrates the planter tray carriage of FIG. 12 with the linkage assembly illustrated in a mobile operation position, in accordance with the present disclosure.

### DETAILED DESCRIPTION

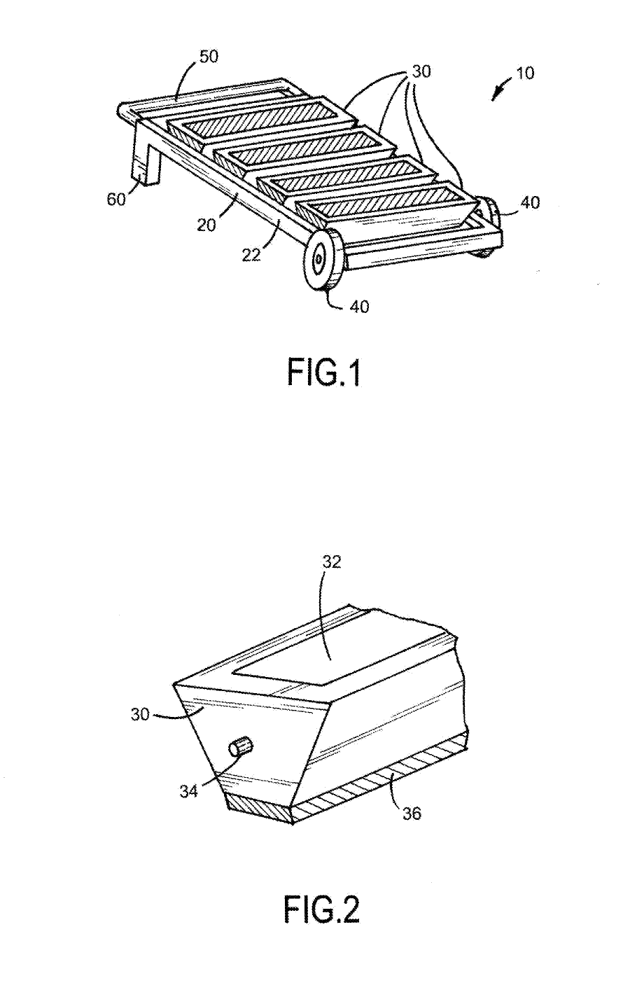

Referring now to the drawings, wherein the showings are for the purpose of illustrating certain exemplary embodiments only and not for the purpose of limiting the same, FIG. 1 illustrates an exemplary planter tray carriage in a horizontal, deployed state. Configuration 10 includes planter tray carriage 20, a plurality of planter trays 30, two carriage wheels 40, a handle 50, and rear support legs 60. Carriage 20 holds the planter trays 30 such that the planter trays can be easily moved all at once, for example, permitting a person to move four trays at a time to be in the sunlight all day. Planter trays 30 are mounted to side supports 22 of carriage 20 with pivoting tray connections such that the trays can pivot and remain upright whether the carriage is flat on the ground or if handle 50 is picked up and the carriage is at an angle. Carriage 20 can be made of a number of materials, including but not limited to wood, metal (aluminum, steel, etc. in bars, tubes, extruded rectangles, etc.), fiberglass, polymer, or other material. Trays 30 can be made of a number of different materials, including wood, clay, porcelain, metal, polymer, etc.

FIG. 2 illustrates a planter tray from FIG. 1 including pivoting hardware. Exemplary tray 30 is illustrated, including cavity 32 wherein dirt and plants can be placed. In an alternative use, a plurality of pots or a plurality of plastic, disposable planter trays can be placed within cavity 32. Cavity 32 can include depressions or an insertable fixturing tray for securely holding pots in the cavity. Cavity 32 can include holes in the bottom to permit excess water to drain from tray 30. Pivot hardware 34 is illustrated, including an exemplary pin or axle configuration that fits into a mating tray holder configuration on a planter tray carriage. The illustrated pin is exemplary, and a number of configurations are envisioned to permit trays 30 to be pivotably mounted to carriage 20. In one embodiment, the pin can include a head wider than the axle, and mating hardware on the side supports 22 can include features to fixedly trap the head and permit the tray to rotate. The disclosure is not intended to be limited to the particular pivot hardware examples provided herein. Pivot hardware 34 is illustrated near a vertical mid-point of planter tray 30. The orientation of the pivoting tray can be controlled by gravity. The tray 30 can be bottom heavy to prevent the tray from tipping over and dumping out the dirt and plats contained therein. An optional tray weight 36 is illustrated, for example, including a non-corroding metal plate added to the bottom of tray 30. Weight 36 permits tray 30 to sit high as compared to pivot hardware 34 and carriage 20. In another configuration, pivot hardware 34 can be located higher on tray 30 such that more of tray 30 and the dirt therein are below the pivot hardware 34, making tray 30 more stable in an upright position, and can eliminate the need for weight 36. Pivot hardware can be screwed, bolted, adhered, or otherwise attached to tray 30 by any methods known in the art. In another embodiment, the trays can hang or be suspended from the carriage, for example, with wires connecting each end of a tray to the carriage. Pivoting hardware is envisioned in many forms enabling the trays to adjust as the carriage is adjusted to various states, and the disclosure is not intended to be limited to the particular examples provided herein.

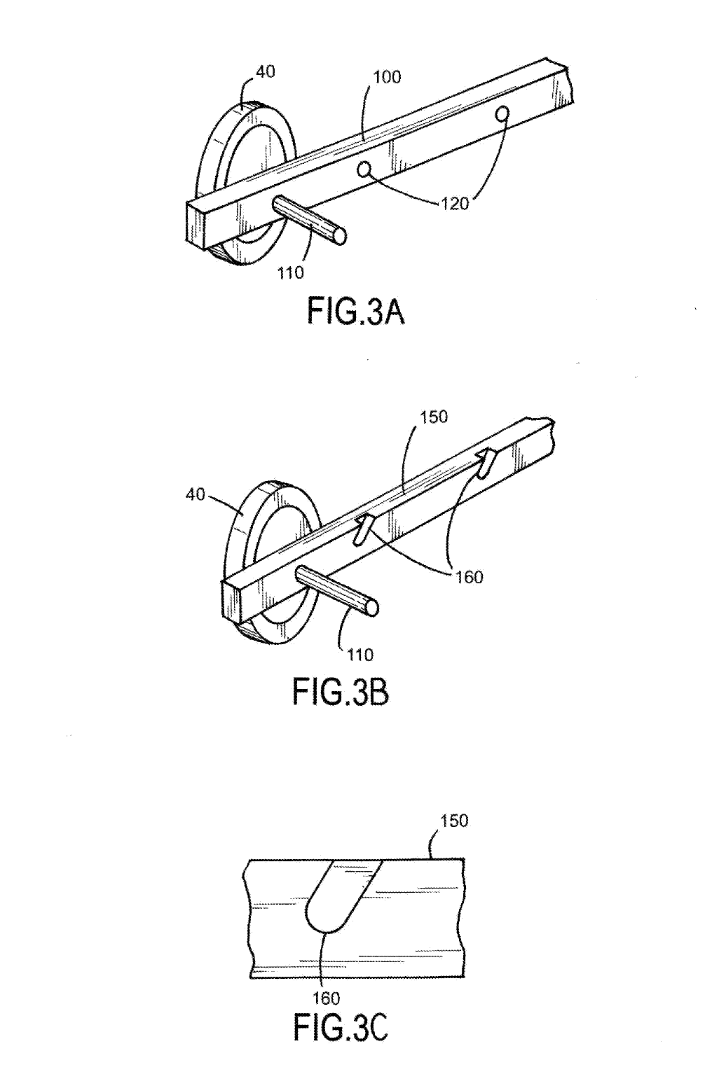

FIG. 3A illustrates an exemplary side support of a planter tray carriage including a first exemplary tray holder configuration. Side support 100 of a planter tray carriage is illustrated including tray holder configuration 120 including a plurality of holes. The holes can be made directly in the material of side support 100. Bearings or bushings can be used in tray holder configuration 120. Trays can semi-permanently fixed with tray holder configuration 120, for example, requiring that the planter tray carriage be unlocked or partially disassembled to remove or replace a tray. Wheel 40 is illustrated including axle 110. A number of wheel configurations are envisioned, for example, including castor wheels or wheels directly mounted to a wheel bracket without an axle connecting the two wheels. According to one embodiment, a wheel bracket on either side of the carriage are mounted to pivot left and right, permitting the carriage to be easily maneuvered. In another embodiment, the pivoting wheel brackets can be selectably fixed, for example with foot levers or with cable controlled orientation fixing hardware connected to a hand lever near the handle of the carriage. A number of wheel configurations are envisioned, and the disclosure is not intended to be limited to the particular examples provided herein.

FIG. 3B illustrates an exemplary side support of a planter tray carriage including a second exemplary tray holder configuration. Side support 150 is illustrated including wheel 40, axle 110, and tray holder configuration 160. Tray holder configuration 160 includes angled slots, wherein pivot hardware can be inserted. The angled slots can be advantageous, as the trays can be easily removed from the carriage, permitting flexibility in use of the carriage. If the plants get too big or too heavy, moving the carriage into an upright or vertical position can damage the plants or be too unwieldy for the user. By removing one or more of the trays, more room between the trays is made available and the carriage is less heavy. The angled slots can be cut directly into the material of side support 150. In another embodiment, a metallic or polymer insert can be used in the slot to hold the pivot hardware. In another embodiment, pivot hardware such as a pin or axle can be mounted to the side support, and a mating configuration on the tray can be used, such as an upside-down U-shaped bracket.

FIG. 3C illustrates the tray holder configuration of FIG. 3B. The exemplary angled slot 160 of side support 150 permits the tray to be held in the slot by gravity whether the carriage is in a horizontal or vertical state.

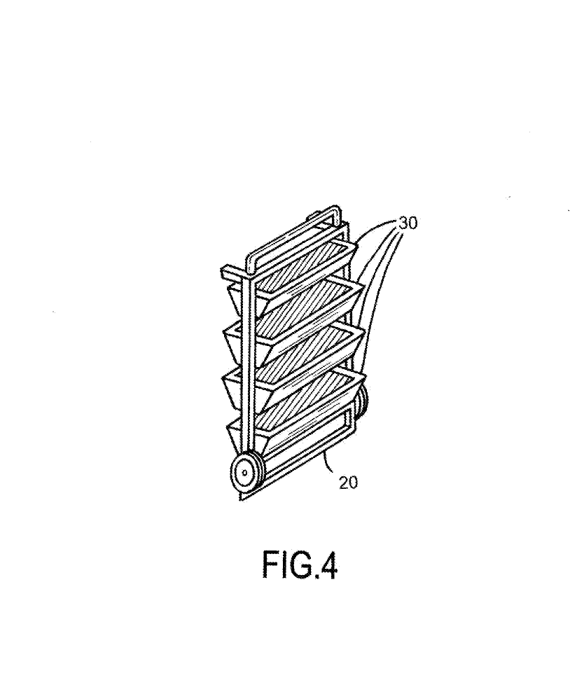

FIG. 4 illustrates the planter tray carriage of FIG. 1 in a vertical state. Carriage 20 includes trays 30. Carriage 20 is in a vertical position or upright orientation, such that the carriage can be stored in a position taking up little floor space. Trays 30 pivot in relation to carriage 20, such that the trays remain upright. Sufficient space is left between the trays, such that plants below a certain height can sit in one tray without contacting the bottom of the tray above them.

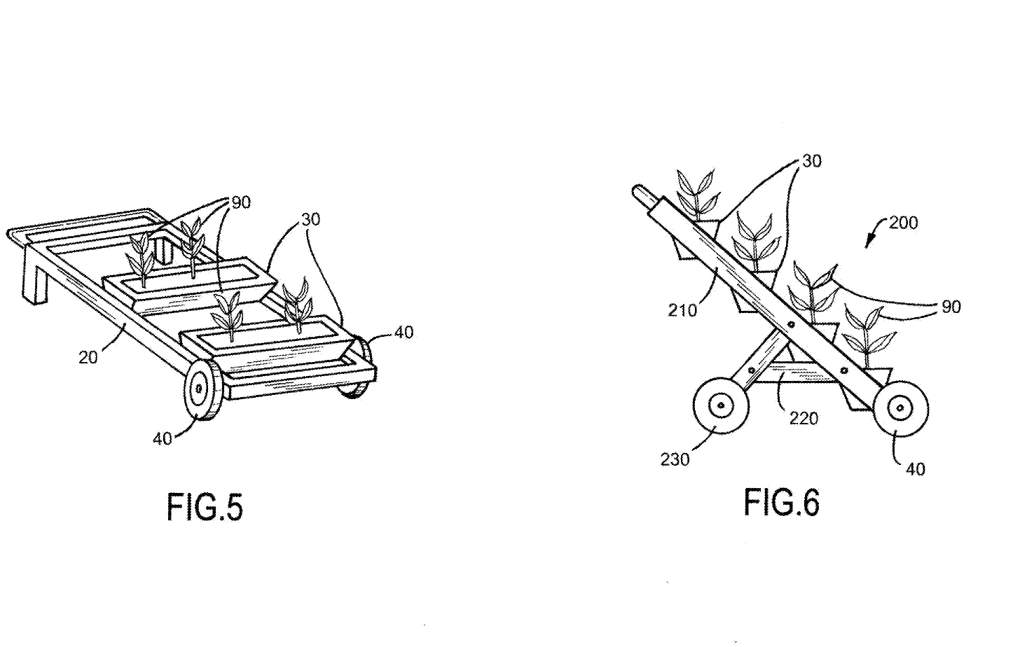

FIG. 5 illustrates an exemplary planter tray carriage with a plurality of mature plants and with two planter trays removed. Carriage 20 is illustrated including two trays 30, wheels 40, and mature plants 90. As plants 90 get above a certain height, the tray above the plant would interfere with the plant if the carriage were moved into a vertical position. In one embodiment, an empty second carriage can be employed to hold the two removed trays from carriage 20.

FIG. 6 illustrates an exemplary planter tray carriage with a wheeled stand employed, providing a partially stowed or angled state for the carriage. Configuration 200 illustrates carriage 210 including trays 30 holding mature plants 90, wheels 40, and support structure 220 including wheels 230. By holding trays 30 in an angled orientation, the carriage takes up less floor space than a fully horizontal carriage. Support structure 220 can be adjustable, for example, permitting the carriage 210 to be held in a nearly vertical state but still permitting plants 90 to sit in front of the tray above them or lowered into a horizontal or nearly horizontal position, with the trays aligned to a floor surface.

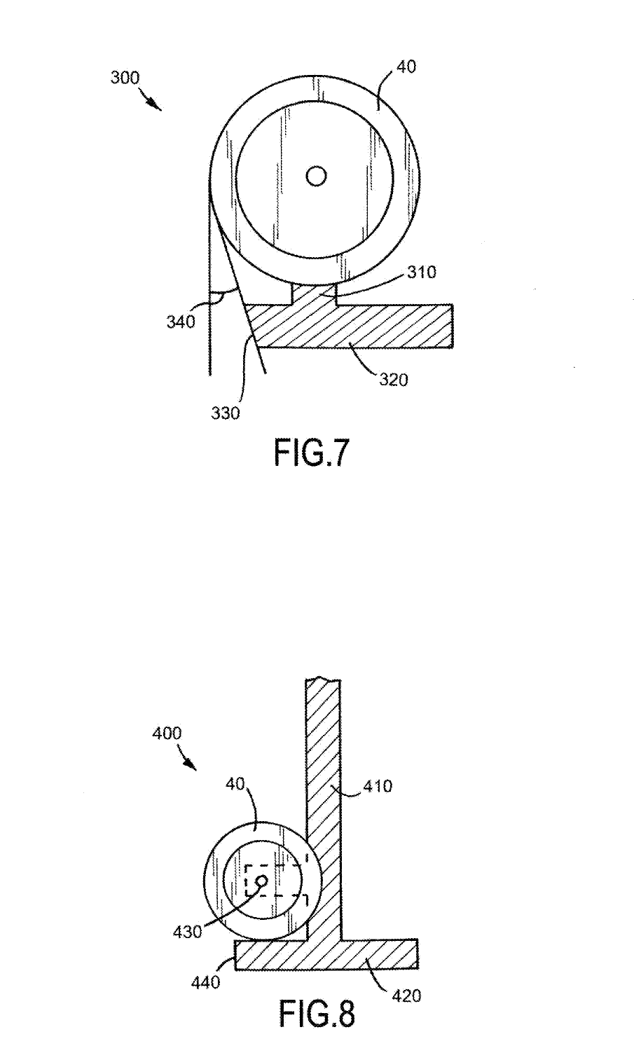

FIG. 7 illustrates an exemplary planter tray carriage with a first flat end configuration, facilitating a vertical, stowed state. Configuration 300 illustrates carriage 310. Carriage 310 includes flat end 320, such that the carriage can be stable in a vertical position. Carriage 310 also includes wheel 40 mounted to a side support of carriage 310. An edge 330 is configured according to design angle 340 to permit carriage 20 to be moved around by a user in a semi-horizontal state, using wheels 40 to maneuver, without edge 330 hitting the ground. The carriage can be additionally stabilized in the vertical position by wall brackets, a kick stand as is used on a bicycle or motorcycle, or by other similar devices. Edge 330 can be reinforced with a metal plate or other similar device based upon the edge being the contact point with the ground when the carriage is tipped into the vertical state. Flat end 320 can include an anti-slip tape or other rough surface feature such that a carriage positioned in the stowed or vertical position will be unlikely to slip or move relative to the floor surface beneath end 320.

FIG. 8 illustrates an exemplary planter tray carriage with a second flat end configuration, facilitating a vertical, stowed state. Configuration 400 illustrates carriage 410. Carriage 410 includes flat end 420, wheel bracket 430 and wheel 40. Wheel bracket 430 extends the wheel away from the side support of carriage 410. This permits flat end 420 to be larger and symmetrical to the side support of carriage 410, enhancing the stability of carriage 410 in the vertical or stowed state. In another embodiment, wheel 40 can be omitted. In such an embodiment, one side of flat end 420 can be curved or include a roller device to permit the carriage to be slid across a floor surface.

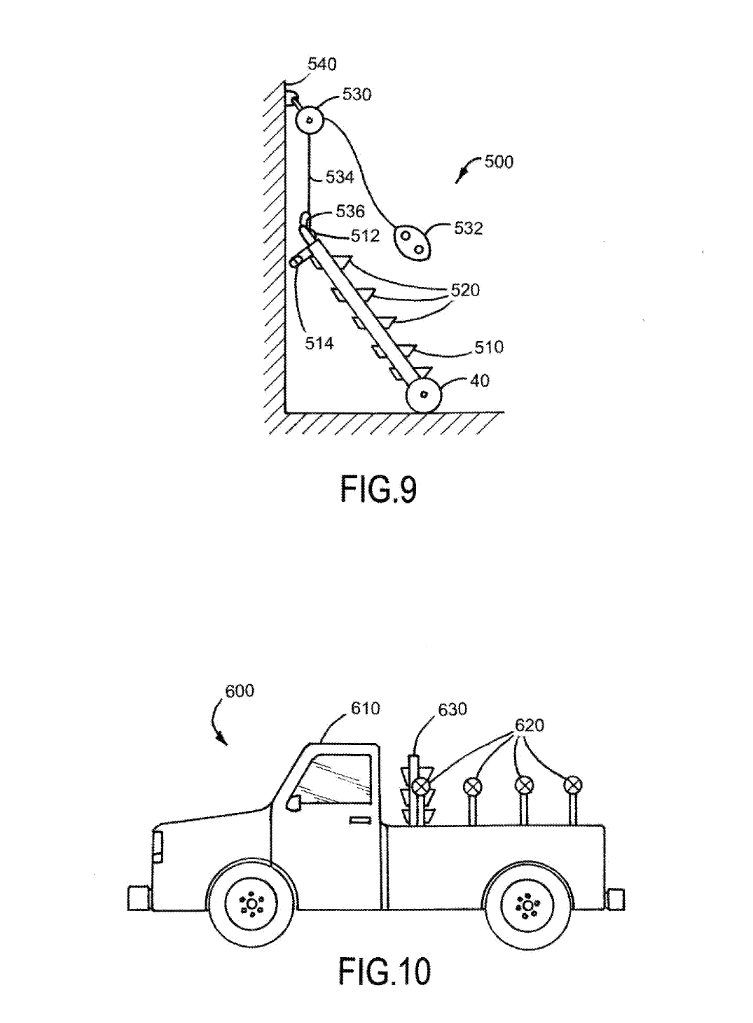

FIG. 9 illustrates an exemplary planter tray carriage and a powered wall storage unit. Configuration 500 illustrates carriage 510 including trays 520, wheel 40, rear wheel 514, and handle 512. Motor 530 is mounted to wall 540 and is controlled by unit 532 to provide movable line 534 for raising or lowering carriage 510 to and from the vertical position. A quick release device 536 can be attached to line 534 such that carriage 510 can be easily removed from the line and moved freely. Unit 532 is one example of how motors can be controlled. Other non-limiting embodiments include control by a remote hand-held device (by radio frequency, by telecommunications network, or other similar methods) or by voice activation through a computerized controller.

FIG. 10 illustrates a truck with exemplary planter tray carriage fixing hardware. A merchant can bring a plurality of planter trays or carriages loaded with trays to a farmer's market. Configuration 600 illustrates truck 610 with four sets of carriage fixing hardware 620. Each set of carriage fixing hardware can engage a carriage 630 in a vertical state in the bed of the truck, such that truck 610 can hold four exemplary carriages. Carriage fixing hardware 620 can be configured to receive mating brackets on either side of carriage 630, such that the carriages can be wheeled into the truck, stood up into the vertical position, and engaged to a hardware set and securely held for transport. In this way, a merchant can supply with minimal effort a number of live plants from which customers at a market can directly pick produce or purchase trays of life plants.

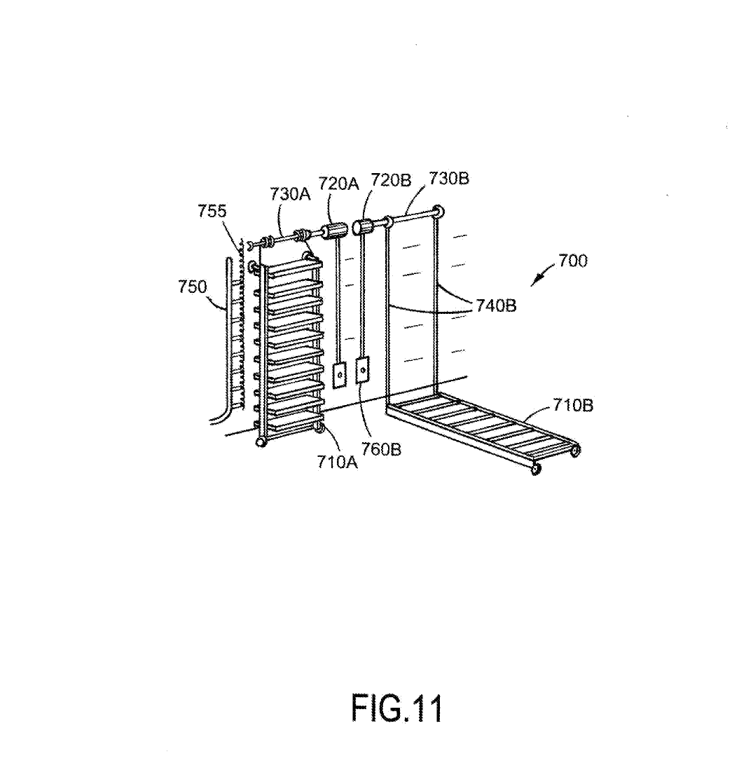

FIG. 11 illustrates a plurality of planter tray carriages for use in a retail store, including powered wall storage units and an automatic watering fixture. Configuration 700 illustrates planter tray carriages 710A in a vertical state and planter tray carriage 710B in a horizontal state. The carriages are controlled by electric motors 720A and 720B respectively, each turning a spool device 730A and 730B, respectively. Lines 740B are illustrated connected to carriage 710B. Activation of controller 760B controls motor 720B, which spools or unspools lines 740B upon spool device 730B. An automatic watering fixture 750 can be located to apply water mist 755 to the carriages, thereby watering the plants and eliminating a need to water the plants while the respective carriages are deployed upon the floor in the horizontal state. Configuration 700 permits long rows of trays to be presented to customers for purchase, while also permitting the carriages to be stowed in the vertical state and the floor to be efficiently cleaned.

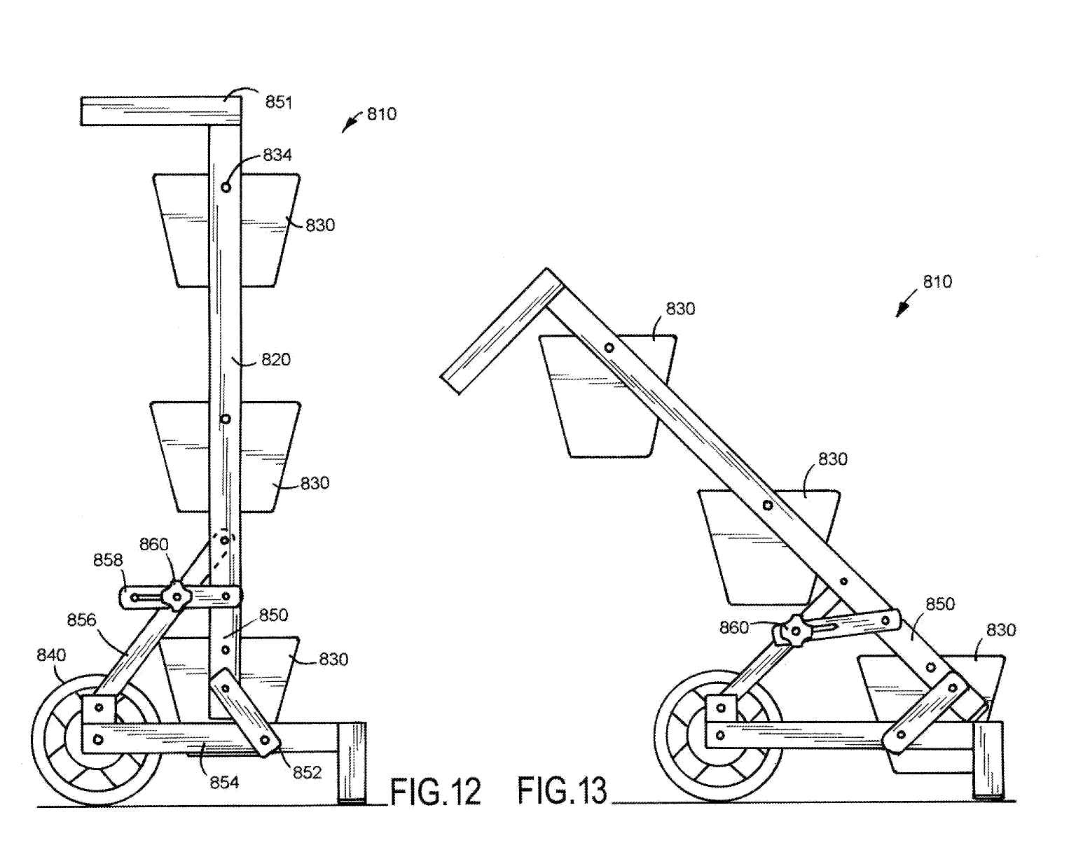

FIG. 12 illustrates an exemplary planter tray carriage with a wheeled stand employed, the stand including a moving linkage assembly and a position locking device, the linkage assembly illustrated in a stowed position. Planter tray carriage 810 is illustrated including side supports 820, handle 851, trays 830, wheels 840, and moving linkage assembly 850. Moving linkage assembly 850 includes a plurality of linkage members 852, 854, 856, and 858 connected to side supports 820, wherein the linkage members include pivot points permitting carriage 810 to adjust between at least two positions. In the exemplary embodiment of FIG. 12, carriage 810 is illustrated in a vertical or stowed position. Linkage members 856 and 858 interact with a position locking device 860 permitting one to lock assembly 850 into a desired position. Exemplary device 860 can include a threaded fastener clamping linkage members 856 and 858 together, wherein the fastener can include an enlarged nut permitting a user to easily fasten or loosen the fastener.

FIG. 13 illustrates the planter tray carriage of FIG. 12 with the linkage assembly illustrated in an angled position or mobile operation position. Carriage 810 is illustrated in an angled or mobile operation position. The carriage can be moveable in a vertical position, however, the carriage can be easier to move and less likely to tip in an angled position. In another embodiment, the wheels 840 can be caused to lock in a vertical position and unlock in an angled position. Trays 830 are permitted to pivot or rotate as disclosed herein. Moving linkage assembly 850 and position locking device 860 are illustrated adjusted to a configuration enabling the angled position.

Adjustment of carriage 810 can be enabled in a number of states. In one embodiment, a carriage can be stored in a nearly upright state, for example, with an eighty degree angle to the horizontal floor surface, and then deployed in an angled state, for example, with a forty degree angle to the horizontal floor surface.

Side supports are illustrated herein with fixed tray holder configurations at fixed locations. Other configurations are envisioned, for example, with side supports with multiple holes drilled along the length of the support such that a tray holding brackets can be assembled to any desired locations along the sides of the side supports, making the locations of the trays changeable.

The carriage can be configured to transition between the fully vertical state and a horizontal state. In another embodiment, a carriage can be configured to transition between a nearly vertical state or diagonal state and still be used according to the methods disclosed herein.

The carriages disclosed herein are discussed being operable or being configured to be used in a plurality of states or positions. These plurality of states can include a horizontal position wherein the carriage is aligned to a floor surface. The plurality of states can include a vertical position wherein the carriage is in an upright configuration. The plurality of states can include an angled position wherein the trays are configured in progressively higher positions from one end of the carriage to another. A number of states and corresponding positions are envisioned for the disclosed carriages, a carriage may be adjustable through more than two and up to an infinite number of states, and the disclosure is not intended to be limited to the particular exemplary positions disclosed herein.

In one embodiment, the disclosure can include an apparatus including a planter tray carriage operable in a vertical, stowed state and an angled state. The carriage can include a plurality of planter trays, each planter tray being rectangular in shape and comprising two narrow sides and two elongated sides. The carriage can further include two carriage side supports aligned along and rotatingly connected to the narrow sides of the planter trays. The trays can be configured to rotate and maintain an upright orientation when the carriage is transitioned between the vertical state and the angled state.

The disclosure has described certain preferred embodiments and modifications of those embodiments. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. An apparatus comprising a planter tray carriage operable in a plurality of states, wherein the states enable selective upright storage of the carriage or deployment of the carriage, the carriage comprising:
a plurality of planter trays attached to the carriage and configured to remain upright in each of the plurality of states.

2. The apparatus of claim 1, wherein the carriage further comprises a pair of side supports; and
wherein the planter trays are attached to the side supports through pivoting tray connections.

3. The apparatus of claim 2, wherein the pivoting tray connections comprise a pin connected to each end of each tray.

4. The apparatus of claim 3, wherein the pivoting tray connections further comprise holes formed in the side supports, the holes being configured to rotatingly hold the pins.

5. The apparatus of claim 3, wherein the pivoting tray connections further comprise slots formed in the side supports, the slots being configured to rotatingly hold the pins while permitting the pins to be lifted out of the slots.

6. The apparatus of claim 2, wherein each of the pivoting tray connections are located proximate to a top end of one of the trays, such that gravity maintains the tray in an upright position.

7. The apparatus of claim 1, wherein each of the trays include a weight affixed to a bottom of the tray, such that gravity maintains the tray in an upright position.

8. The apparatus of claim 1, wherein the carriage is connected to a powered wall storage unit selectively lifting and lowering the carriage between a vertical state and a horizontal state.

9. The apparatus of claim 1, wherein the carriage is connected to carriage fixing hardware located within a motor vehicle.

10. The apparatus of claim 1, wherein the carriage further comprises a wheeled stand permitting the carriage to be operated in an angled state.

11. The apparatus of claim 10, wherein the wheeled stand comprises:
a moving linkage assembly permitting adjustment of the carriage between the plurality of states; and
a position locking device permitting the carriage to be locked in one of the states.

12. The apparatus of claim 1, wherein the plurality of states comprise a horizontal position wherein the carriage is aligned to a floor surface.

13. The apparatus of claim 1, wherein the plurality of states comprise a vertical position wherein the carriage is in an upright configuration.

14. The apparatus of claim 13, wherein the carriage further comprises a flat end configuration enabling the carriage to stand in the vertical position.

15. An apparatus comprising a planter tray carriage operable in a vertical, stowed state and second state, the carriage comprising:
a plurality of planter trays;
carriage side supports; and
pivoting tray connections for holding the plurality of planter trays, the connections permitting the trays to remain in an upright orientation in the vertical state and the second state.

16. An apparatus comprising a planter tray carriage operable in a vertical, stowed state and an angled state, the carriage comprising:
a plurality of planter trays, each planter tray being rectangular in shape and comprising two narrow sides and two elongated sides; and
two carriage side supports aligned along and rotatingly connected to the narrow sides of the planter trays; and
wherein the trays are configured to rotate and maintain an upright orientation when the carriage is transitioned between the vertical state and the angled state.
